(19) United States
(12) Patent Application Publication
(10) Pub. No.: US 2026/0070267 A1
(43) Pub. Date: Mar. 12, 2026

(54) HOLLOW BALL CORE FOR SANDWICH STRUCTURED COMPOSITES

(71) Applicants: Dae Han Sung, Logan, UT (US); Gavin Stoker, Logan, UT (US)

(72) Inventors: Dae Han Sung, Logan, UT (US); Gavin Stoker, Logan, UT (US)

(73) Assignee: Utah State University, Logan, UT (US)

(21) Appl. No.: 19/323,912

(22) Filed: Sep. 9, 2025

Related U.S. Application Data
(60) Provisional application No. 63/692,755, filed on Sep. 10, 2024.

(51) Int. Cl. B29C 43/20; B29C 43/36; B29C 43/52; B29K 23/00; B29L 7/00; B32B 3/12; B32B 27/08; B32B 27/32

(52) U.S. Cl. CPC B29C 43/206; B29C 43/3642; B29C 43/52; B32B 3/12; B32B 27/08; B32B 27/32; B29C 2043/3649; B29K 2023/12; B29L 2007/002; B32B 2250/03; B32B 2250/242; B32B 2250/40; B32B 2607/00

(57) ABSTRACT

A method of the present disclosure includes inserting thermoplastic components into a mold such that at least two or more thermoplastic components are adhered to an inner wall of the mold. The thermoplastic components are substantially hollow and made of a thermoplastic material. The method includes applying pressure onto the thermoplastic components adhered to the inner wall in a direction towards the inner wall of the mold to compress the thermoplastic components. The method includes heating the thermoplastic components concurrently with applying the pressure such that a first portion of the thermoplastic material of the thermoplastic components forms a first sheet on a first side of the thermoplastic components and a second portion of the thermoplastic material of the thermoplastic components forms a second sheet on a second side of the thermoplastic components opposite to the first side. The first sheet connects the plurality of thermoplastic components.

### CROSS-REFERENCES TO RELATED APPLICATIONS

This application claims the benefit of U.S. Provisional Patent Application No. 63/692,755 entitled “HOLLOW BALL CORE FOR SANDWICH STRUCTURED COMPOSITES” and filed on Sep. 10, 2024 for Dae Han Sung et al., which is incorporated herein by reference.

### FIELD

This invention relates to composites and more particularly relates to sandwich structured composites.

### BACKGROUND

Due to their high strength-to-weight ratio, composite materials can perform well in applications such as aerospace, automotive, and/or marine industries. These materials can include a reinforcement material, such as fibers or particles, and a matrix or binding material. The reinforcement material and binding material have different chemical or physical properties, resulting in a composite material with enhanced characteristics with respect to its constituent materials.

### SUMMARY

A method for hollow ball cores for sandwich structured composites includes inserting a plurality of thermoplastic components into a mold such that at least two or more thermoplastic components of the plurality of thermoplastic components are adhered to the inner wall of the mold via the adhesive material. The plurality of thermoplastic components are substantially hollow and made of a thermoplastic material. The method includes applying pressure onto the two or more thermoplastic components adhered to the inner wall in a direction towards the inner wall of the mold to compress the plurality of thermoplastic components. The method includes heating the plurality of thermoplastic components concurrently with applying the pressure such that a first portion of the thermoplastic material of the thermoplastic components forms a first sheet on a first side of the plurality of thermoplastic components and a second portion of the thermoplastic material of the thermoplastic components forms a second sheet on a second side of the plurality of thermoplastic components opposite to the first side. The first sheet connects the plurality of thermoplastic components.

An apparatus for hollow ball cores for sandwich structured composites includes a mold that includes an inner wall. The apparatus includes a plurality of thermoplastic components configured to be inserted into the mold such that at least two or more thermoplastic components of the plurality of thermoplastic components are adhered to the inner wall of the mold. The plurality of thermoplastic components are substantially hollow and made of a thermoplastic material. The apparatus includes a pressure applicator configured to apply pressure onto the two or more thermoplastic components adhered to the inner wall in a direction towards the inner wall of the mold to compress the plurality of thermoplastic components. The apparatus includes a heater configured to heat the plurality of thermoplastic components concurrently with the pressure applicator applying the pressure such that a first portion of the thermoplastic material of the thermoplastic components forms a first sheet on a first side of the plurality of thermoplastic components and a second portion of the thermoplastic material of the thermoplastic components forms a second sheet on a second side of the plurality of thermoplastic components opposite to the first side. The first sheet connects the plurality of thermoplastic components.

Another method for hollow ball cores for sandwich structured composites includes applying an adhesive material onto an inner wall of a mold. The mold has a variable depth. The method includes inserting a plurality of thermoplastic components into the mold such that thermoplastic components of the plurality of thermoplastic components are adhered to the inner wall of the mold via the adhesive material and substantially cover the inner wall of the mold. The plurality of thermoplastic components are substantially hollow, are made of a thermoplastic material, and have different dimensions corresponding to the variable depth of the mold. The method includes removing thermoplastic components of the plurality of thermoplastic components that are not adhered to the inner wall from the mold. The method includes applying pressure onto the two or more thermoplastic components adhered to the inner wall in a direction towards the inner wall of the mold to compress the plurality of thermoplastic components by: disposing the plurality of thermoplastic components between the mold and another mold, and moving the mold and the another mold towards each other; applying gas pressure onto the plurality of thermoplastic components towards the mold; and/or filling a bladder that is in contact with the thermoplastic components, thus applying pressure on the thermoplastic components. The method includes heating the plurality of thermoplastic components concurrently with applying the pressure such that: (1) a first portion of the thermoplastic material of the thermoplastic components forms a first sheet on a first side of the plurality of thermoplastic components; (2) a second portion of the thermoplastic material of the thermoplastic components forms a second sheet on a second side of the plurality of thermoplastic components opposite to the first side where the first sheet connects the plurality of thermoplastic components; and (3) the adhesive at least partially evaporates. The method includes removing the plurality of thermoplastic components, the first sheet, and the second sheet from the mold.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating an apparatus for hollow ball cores for sandwich structured composites, according to various embodiments;

FIG. 2A is a perspective view illustrating a mold for hollow ball cores for sandwich structured composites, according to various embodiments;

FIG. 2B is a perspective view illustrating the mold of FIG. 2A with an adhesive, according to various embodiments;

FIG. 2C is a perspective view illustrating the mold of FIG. 2A filled with a plurality of thermoplastic components covering the adhesive, according to various embodiments;

FIG. 2D is a side elevation view illustrating the mold of FIG. 2A with the plurality of thermoplastic components disposed between the mold and another mold, according to various embodiments;

FIG. 2E is a side section view illustrating the side view of the mold and thermoplastic components and other mold of FIG. 2D and an active heating element, according to various embodiments;

FIG. 2F is a side section view illustrating the side view of the mold and thermoplastic components and other mold of FIG. 2D and an active cooling element, according to various embodiments;

FIG. 2G is a side section view illustrating a sandwich composite, according to various embodiments;

FIG. 2H is a top plan view illustrating a honeycomb structure, according to various embodiments;

FIG. 3A is a top cross section view illustrating a mold, according to various embodiments;

FIG. 3B is a top cross section view illustrating a plurality of thermoplastic components in the mold of FIG. 3A, according to various embodiments;

FIG. 3C is a top cross section view illustrating the mold of FIG. 3A with a subset of the plurality of thermoplastic components adhered to an inner wall of the mold, according to various embodiments;

FIG. 3D is a top cross section view illustrating the mold and thermoplastic components of FIG. 3C with an uninflated bladder, according to various embodiments;

FIG. 3E is a top cross section view illustrating the mold and thermoplastic components of FIG. 3C with the bladder being filled, according to various embodiments;

FIG. 3F is a top cross section view illustrating the mold and thermoplastic components of FIG. 3C with a filled bladder, according to various embodiments;

FIG. 4 is a side elevation view illustrating a mold having a variable depth and thermoplastic components of various diameters, according to various embodiments;

FIG. 5 is a schematic block diagram illustrating an apparatus with a mold with adhesive and thermoplastic components and with a gas pressure applicator, according to various embodiments;

FIG. 6 is a schematic flow chart diagram illustrating a method, according to various embodiments; and

FIG. 7 is a schematic flow chart diagram illustrating another example of a method, according to various embodiments.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.

Examples of the present disclosure include a method for hollow ball cores for sandwich structured composites. The method includes inserting a plurality of thermoplastic components into a mold such that at least two or more thermoplastic components of the plurality of thermoplastic components are adhered to the inner wall of the mold via the adhesive material. The plurality of thermoplastic components are substantially hollow and made of a thermoplastic material. The method includes applying pressure onto the two or more thermoplastic components adhered to the inner wall in a direction towards the inner wall of the mold to compress the plurality of thermoplastic components. The method includes heating the plurality of thermoplastic components concurrently with applying the pressure such that a first portion of the thermoplastic material of the thermoplastic components forms a first sheet on a first side of the plurality of thermoplastic components and a second portion of the thermoplastic material of the thermoplastic components forms a second sheet on a second side of the plurality of thermoplastic components opposite to the first side. The first sheet connects the plurality of thermoplastic components.

In some examples, the mold has a variable depth and the plurality of thermoplastic components have different dimensions corresponding to the variable depth of the mold. In some examples, the variation of the variable depth is non-linear and the variable depth comprises at least three different depth values.

In some examples, the method includes removing thermoplastic components of the plurality of thermoplastic components that are not adhered to the inner wall from the mold prior to applying pressure onto the two or more thermoplastic components adhered to the inner wall. In some examples, applying the pressure includes at least one of: disposing the plurality of thermoplastic components between the mold and another mold, and moving the mold and the another mold towards each other; applying gas pressure onto the plurality of thermoplastic components towards the mold; and/or filling a bladder, wherein the bladder is in contact with the thermoplastic components and filling the bladder applies pressure on the thermoplastic components.

In some examples, the method includes applying an adhesive material onto an inner wall of the mold prior to inserting the plurality of thermoplastic components into the mold. The plurality of thermoplastic components are adhered to the inner wall of the mold via the adhesive material. Heating the plurality of thermoplastic components includes heating the plurality of thermoplastic components such that the adhesive at least partially evaporates and the plurality of thermoplastic components, the first sheet, and the second sheet are removable from the mold.

In some examples, the thermoplastic components are substantially spherical when inserted into the mold and applying pressure to the plurality of thermoplastic components includes compressing the thermoplastic components such that the thermoplastic components are not spherical. In some examples, applying the pressure to the plurality of thermoplastic components includes compressing the thermoplastic components such that the thermoplastic components are shaped substantially similar to a hexagonal prism. In some examples, applying the pressure to the plurality of thermoplastic components includes compressing the thermoplastic components such that the thermoplastic components form a honeycomb structure between the first sheet and the second sheet. In some examples, applying the pressure to the plurality of thermoplastic components includes compressing the thermoplastic components such that a distance between the first sheet and the second sheet is not less than 40 percent and not greater than 80 percent of a diameter of the substantially spherical thermoplastic components.

In some examples, the method includes cooling the thermoplastic material. In some examples, the thermoplastic material includes polypropylene and cooling the thermoplastic material includes air cooling the thermoplastic material at a rate of not less than 1.5 and not greater than 5.5 degrees Celsius per minute. In some examples, the thermoplastic material includes polypropylene and cooling the thermoplastic material includes water cooling the thermoplastic material at a rate of not less than 13 and not greater than 21 degrees Celsius per minute.

In some examples, heating the plurality of thermoplastic components includes heating the plurality of thermoplastic components to a temperature that is greater than or equal to a glass transition temperature of the thermoplastic material and less than a melting temperature of the thermoplastic material.

In some examples, inserting the plurality of thermoplastic components into the mold such that at least two or more thermoplastic components of the plurality of thermoplastic components are adhered to the inner wall of the mold includes the inner wall being substantially covered with the thermoplastic components.

An apparatus for hollow ball cores for sandwich structured composites includes a mold that includes an inner wall. The apparatus includes a plurality of thermoplastic components configured to be inserted into the mold such that at least two or more thermoplastic components of the plurality of thermoplastic components are adhered to the inner wall of the mold. The plurality of thermoplastic components are substantially hollow and made of a thermoplastic material. The apparatus includes a pressure applicator configured to apply pressure onto the two or more thermoplastic components adhered to the inner wall in a direction towards the inner wall of the mold to compress the plurality of thermoplastic components. The apparatus includes a heater configured to heat the plurality of thermoplastic components concurrently with the pressure applicator applying the pressure such that a first portion of the thermoplastic material of the thermoplastic components forms a first sheet on a first side of the plurality of thermoplastic components and a second portion of the thermoplastic material of the thermoplastic components forms a second sheet on a second side of the plurality of thermoplastic components opposite to the first side. The first sheet connects the plurality of thermoplastic components.

In some examples, the pressure applicator includes at least one of the following: another mold; a press configured to move the mold and the another mold towards each other; a pressurizer configured to apply gas pressure onto the plurality of thermoplastic components towards the mold; and/or a bladder in contact with the thermoplastic components and configured to be filled to apply pressure on the thermoplastic components.

In some examples, the apparatus includes an air cooler configured to cool the thermoplastic material at a rate of not less than 1.5 and not greater than 5.5 degrees Celsius per minute, and the thermoplastic material comprises polypropylene. In some examples, the apparatus includes a water cooler configured to cool the thermoplastic material at a rate of not less than 13 and not greater than 21 degrees Celsius per minute.

Another method for hollow ball cores for sandwich structured composites includes applying an adhesive material onto an inner wall of a mold. The mold has a variable depth. The method includes inserting a plurality of thermoplastic components into the mold such that thermoplastic components of the plurality of thermoplastic components are adhered to the inner wall of the mold via the adhesive material and substantially cover the inner wall of the mold. The plurality of thermoplastic components are substantially hollow, are made of a thermoplastic material, and have different dimensions corresponding to the variable depth of the mold. The method includes removing thermoplastic components of the plurality of thermoplastic components that are not adhered to the inner wall from the mold. The method includes applying pressure onto the two or more thermoplastic components adhered to the inner wall in a direction towards the inner wall of the mold to compress the plurality of thermoplastic components by: disposing the plurality of thermoplastic components between the mold and another mold, and moving the mold and the another mold towards each other; applying gas pressure onto the plurality of thermoplastic components towards the mold; and/or filling a bladder that is in contact with the thermoplastic components, thus applying pressure on the thermoplastic components. The method includes heating the plurality of thermoplastic components concurrently with applying the pressure such that: (1) a first portion of the thermoplastic material of the thermoplastic components forms a first sheet on a first side of the plurality of thermoplastic components; (2) a second portion of the thermoplastic material of the thermoplastic components forms a second sheet on a second side of the plurality of thermoplastic components opposite to the first side where the first sheet connects the plurality of thermoplastic components; and (3) the adhesive at least partially evaporates. The method includes removing the plurality of thermoplastic components, the first sheet, and the second sheet from the mold.

Sandwich-structured composites include composite materials made by bonding two outer layers, or sheets, to a core. The core is a thicker, lightweight inner layer. Sandwich-structured composites have high strength-to-weight and stiffness-to-weight ratios, making them highly efficient structural materials and beneficial for aerospace, marine, automotive, constructive, and clean energy applications. Manufacturing sandwich-structured composites can be complex, and some techniques may result in defects like delamination. These challenges can increase with the complexity of the structure's geometry. Examples of the present disclosure provide an apparatus and methods for forming sandwich-structured composites that can help to simplify the manufacturing process, reduce error, and facilitate manufacturing of composites with more complex geometries.

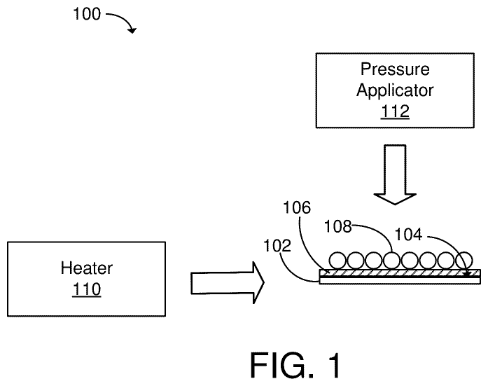

FIG. 1 is a schematic block diagram illustrating an apparatus 100 for hollow ball cores for sandwich structured composites, according to various embodiments. The apparatus 100 includes a mold 102 having an inner wall 104, an adhesive 106, a plurality of thermoplastic components 108, a heating element 110, and a pressure applicator 112.

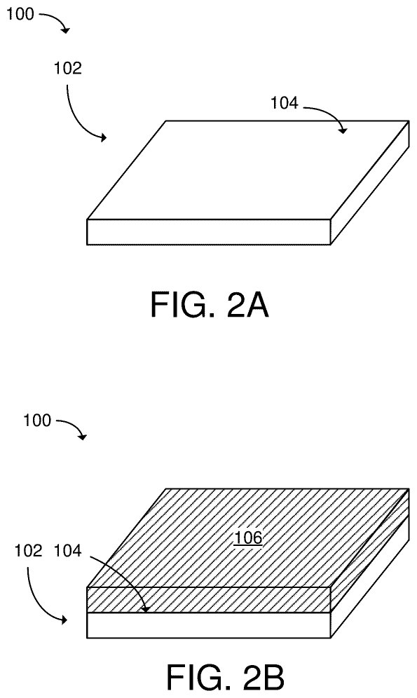

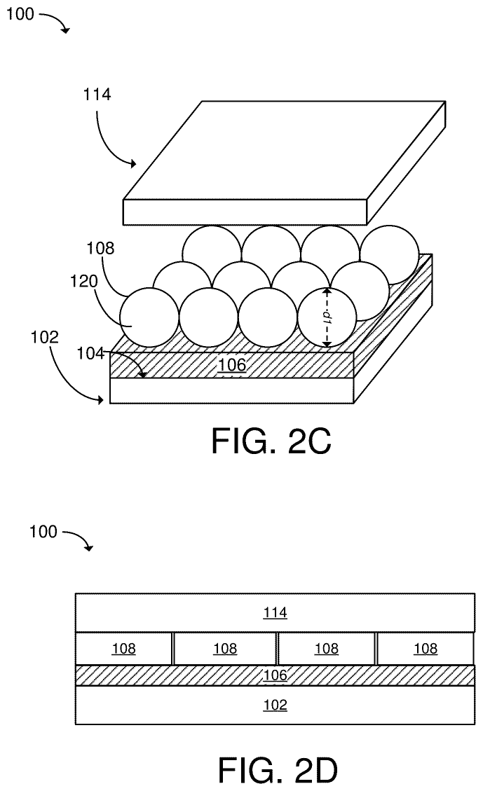

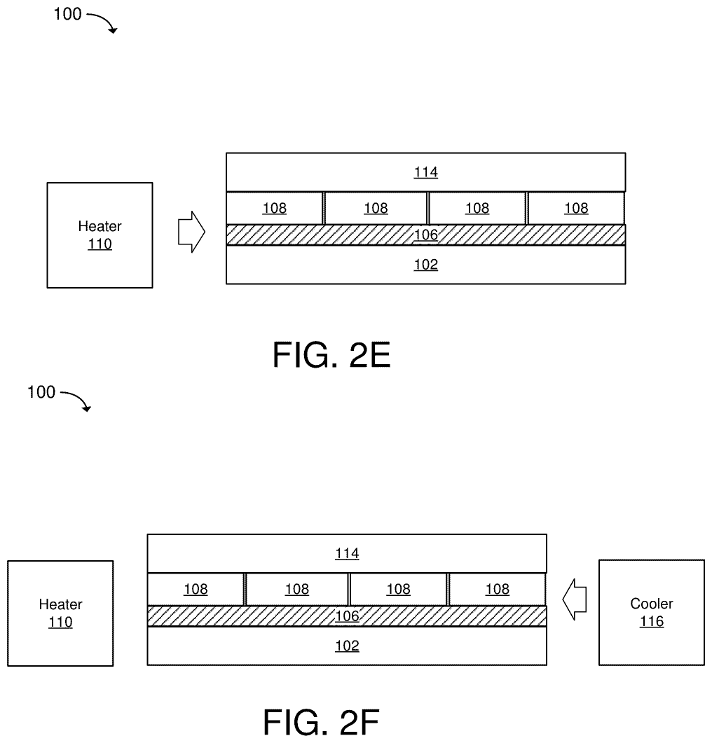

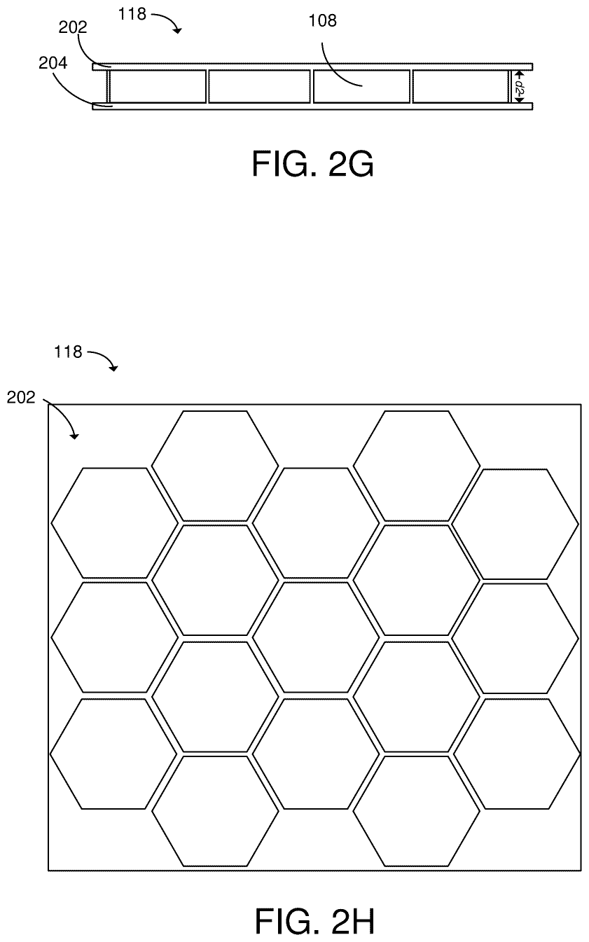

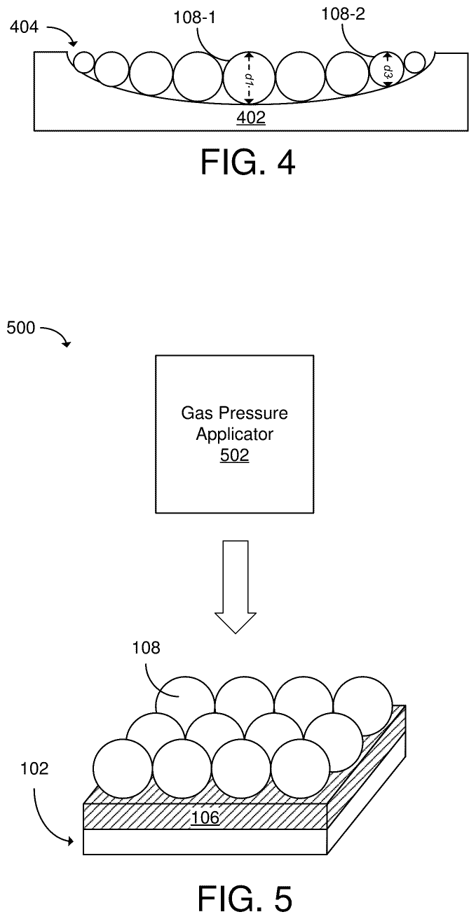

In some examples, the mold 102 includes a single, substantially planar surface. In some examples, the mold 102 includes a cavity. In various examples, the mold 102 is a slot of an enclosed structure. Referring to FIG. 4, in some examples, the mold 102 includes a cavity having a variable depth. In some examples, the mold 102 is made of a metallic material, such as steel, aluminum, etc. In some examples, the inner wall 104 of the mold 102 is shaped based on a desired shape of a core of a resulting sandwich structure composite, as shown in FIG. 2H. In some examples, the inner wall 104 includes a honeycomb-shaped pattern. In some examples, the inner wall 104 includes a plurality of hexagonal-shaped indentations. In various examples, the thermoplastic components 108 are configured to deform into the shape of the indentations in response to exposure to heat and pressure from the heating element 110 and the pressure applicator 112.

The adhesive material 106 is configured to be applied to the inner wall 104. In some examples, the mold 102 includes a single inner wall 104. In other examples, the mold 102 includes multiple inner walls 104. In some examples, the inner wall 104 is a wall of a cavity within the mold 102. According to one or more examples, the mold 102 includes additional retaining walls that are not covered in the adhesive 106 and are substantially perpendicular to the inner wall 104. In some examples, the apparatus 100 does not include an adhesive 106, and the thermoplastic components 108 are adhered to the inner wall 104 via gravity rather than via the adhesive 106. In some examples, the adhesive material 106 is configured to be applied to the inner wall 104 to substantially cover the inner wall 104 of the mold 102. In some examples, substantially covering the inner wall 104 of the mold 102 includes covering at least 80 percent of an area of one side of the mold 102 with the adhesive material 106.

In other embodiments, the thermoplastic components 108 substantially covering the inner wall 104 includes the thermoplastic components 108 each adhering to the inner wall and touching each other such that a space for an additional thermoplastic component 108 against the inner wall 104 is unavailable. In some embodiments, the mold 102 and/or thermoplastic components 108 are agitated, vibrated, shaken, etc. to move the thermoplastic components 108 around to fill voids against the inner wall 104 to eliminate or minimize any voids in the thermoplastic components 108 against the inner wall 104 and to allow additional thermoplastic components 108 to fill in voids. In some embodiments, the adhesive 106 is applied to the mold 102 in a liquid state and allows the thermoplastic components 108 to move into position before the adhesive 106 sets and holds the thermoplastic components 108 in place.

In some examples, the thermoplastic components 108 are made of a thermoplastic material 120. According to some examples, the thermoplastic components 108 are made entirely of the thermoplastic material 120. In other examples, the thermoplastic components 108 are made of a mixture of the thermoplastic material 120 and another material. In one or more examples, the thermoplastic material 120 includes at least one of: polypropylene, polyethylene, polystyrene, polyamide, polyetherimide, polyether ether ketone, a reinforced thermoplastic, polycarbonate, polyvinyl chloride, polyurethane, polyisocyanurate, polystyrene, or a combination thereof. In some examples, the thermoplastic material 120 is a recyclable material. In some examples, the plurality of thermoplastic components 108 are substantially hollow. In some examples, the volume of each thermoplastic component 108 is at least 80 percent fluid, with thermoplastic material 120 enclosing the fluid to form the thermoplastic components 108. In some examples, the thermoplastic components 108 are filled with fluid, such as air.

The plurality of thermoplastic components 108 are configured to be inserted into and/or onto the mold 102 such that at least two or more thermoplastic components of the plurality of thermoplastic components 108 are adhered to the inner wall 104 of the mold 102 via the adhesive material 106. In some examples, the thermoplastic components 108 substantially cover the inner wall 104 of the mold 102. In various examples, the apparatus 100 covers at least 80 percent of an area of the inner wall 104 with at least one thermoplastic component 108. Some examples include inserting the thermoplastic components 108 into the mold 102 mechanically. In some examples, the thermoplastic components 108 are dropped into and/or onto the mold 102. In various examples, the mold 102 includes a slot, and the thermoplastic components 108 are placed sequentially into the slot.

The pressure applicator 112, in some embodiments, is configured to apply pressure onto the thermoplastic components 108 adhered to the inner wall 104 in a direction towards the inner wall 104 of the mold 102 to deform the thermoplastic components 108. In some examples, the thermoplastic components 108 are substantially hollow, and the pressure applicator 112 is configured to deform the thermoplastic components 108 in a manner that changes a thickness of the thermoplastic components 108. In some examples, the pressure applicator 112 is configured to apply pressure to compress the plurality of thermoplastic components 108. Referring to FIGS. 1 and 2C, in some examples, the pressure applicator 112 includes a press that moves the mold 102 towards another mold 114 and/or moves the other mold 114 towards the mold 102. In such examples, the pressure applicator 112 compresses the thermoplastic components 108 between the two molds 102, 114. In some examples, at least one of the mold 102 and the mold 114 includes a platen. In some examples, the platen includes a substantially flat plate and/or a roller that applies pressure to the thermoplastic components 108 towards the other mold 102 or 114.

In some examples, the pressure applicator 112 is configured to apply pressure at a rate of approximately 3000 pounds per square inch (“psi”) of the area of the mold 102 covered by the thermoplastic components 108. In various examples, the pressure applicator 112 is configured to apply pressure at a rate of not less than 1500 psi and not greater than 4500 psi.

In some examples, the heating element 110 is configured to heat the plurality of thermoplastic components 108 concurrently with the pressure applicator 112 applying the pressure. In various examples, the heating element 110 is configured to commence heating the thermoplastic material 120 of the thermoplastic components 108 prior to the pressure applicator 112 exerting the pressure onto the thermoplastic components 108. According to some examples, the heating element 110 heats the thermoplastic material 120 such that the thermoplastic material 120 is close to its melting point prior to the pressure applicator 112 applying pressure. In some examples, the heating element 110 heats the thermoplastic material 120 to a temperature that is greater than or equal to 70 percent of the melting point of the thermoplastic material 120. In various examples, the heating element 110 heats the thermoplastic material 120 to the desired temperature prior to the pressure applicator 112 applying pressure and does not further heat the thermoplastic material 120 during or after application of pressure from the pressure applicator 112. In some examples, the heating element 110 heats the thermoplastic material 120 such that the thermoplastic components 108 begin to deform before the pressure applicator 112 applies pressure.

In various examples, the heating element 110 is configured to heat the thermoplastic components 108 by heating the mold 102. In one or more examples, the heating element 110 is configured to heat the mold 102 before the mold 102 receives the thermoplastic components 108. In some examples, the heating element 110 is configured to heat the mold 102 to not less than 170 and not greater than 180 degrees Celsius. In some examples, the heating element 110 is configured to heat the mold 102 to a temperature not less than the glass transition temperature of the thermoplastic material 120 and less than the melting temperature of the thermoplastic material 120.

Referring to FIGS. 1, 2G, and 2H, in some examples, the heating element 110 is configured to heat the thermoplastic components 108 such that a first portion of the thermoplastic material 120 of the thermoplastic components 108 forms a first sheet 202 on a first side of the plurality of thermoplastic components 108 and a second portion of the thermoplastic material 120 of the thermoplastic components 108 forms a second sheet 204 on a second side of the plurality of thermoplastic components 108 opposite to the first side. In some examples, the first sheet 202 connects the plurality of thermoplastic components 108. In various examples, the second sheet 204 also connects the plurality of thermoplastic components. In various examples, the first sheet 202 and the second sheet 204 are made entirely of thermoplastic material 120 melted off from the thermoplastic components 108.

In some examples, the first sheet 202 is substantially parallel to the second sheet 204. In various examples, at least one of the first sheet 202 and the second sheet 204 are non-planar. In some examples, the shape of the sheets 202 and/or 204 reflects the shape of the inner wall 104 of the mold 102. In various examples, the inner wall 104 is non-planar, resulting in non-planar sheets 202 and 204 and an overall sandwich composite 118 that is non-planar.

FIG. 2A is a perspective view illustrating a mold 102 for hollow ball cores for sandwich structured composites, according to various embodiments. As shown in FIG. 2A, in some examples, the mold 102 includes a substantially planar surface. In various examples, the inner wall 104 includes the substantially planar surface. In other embodiments, the inner wall 104 is shaped differently based on a desired shape of an object being formed.

FIG. 2B is a perspective view illustrating the mold of FIG. 2A with an adhesive 106, according to various embodiments. In some examples, the apparatus 100 is configured to coat the inner wall 104 of the mold 102 with the adhesive 106 by blowing the adhesive material 106 into the mold 102. In various examples, the apparatus 100 injects the adhesive material 106 into the mold 102 via injection molding. In other embodiments, the adhesive 106 is applied another way, such as with a brush, with a roller, poured onto the mold 102, etc.

FIG. 2C is a perspective view illustrating the mold 102 of FIG. 2A filled with a plurality of thermoplastic components 108 covering the adhesive 106, according to various embodiments. In various examples, the mold 102 receives the thermoplastic components 108. In some examples, the thermoplastic components 108 are tightly packed within the mold. In various examples, each of the thermoplastic components 108 is in contact with at least one other thermoplastic component 108 after being placed in the mold 102.

In some examples, applying pressure to the thermoplastic components 108 includes disposing the thermoplastic components 108 between the mold 102 and another mold 114 and moving the mold 102 and the other mold 114 towards each other. In some examples, the other mold 114 is configured to mate with the mold 102 to which the thermoplastic components 108 are adhered. In some examples, the mold 102 includes a cavity, and the other mold 114 includes a protrusion that corresponds to the cavity. In some examples, the other mold 114 is a weight that is placed on top of the mold 102. In some examples, one or more of the molds 102, 114 includes a cavity that is shaped corresponding to an outer shape of a desired end-product, such as a propeller. In some examples, the molds 102 and 114 are originally open molds but, when moved towards each other, form one enclosed mold.

FIG. 2D is a side section view illustrating the mold of FIG. 2A with the plurality of thermoplastic components 108 disposed between the mold 102 and another mold 114, according to various embodiments. As shown in FIGS. 2C and 2D, in some examples, the thermoplastic components 108 are substantially spherical when inserted into the mold 102 and applying pressure to the plurality of thermoplastic components 108 compresses the thermoplastic components 108 such that the thermoplastic components 108 are not spherical. In some examples, the thermoplastic components 108 are shaped substantially similar to hexagonal prisms, as illustrated in FIG. 2H. Referring to FIGS. 2D and 2H, applying the pressure to the plurality of thermoplastic components 108 includes compressing the thermoplastic components 108 such that the thermoplastic components 108 form a honeycomb structure between the first sheet 202 and the second sheet 204.

FIG. 2E is a side section view illustrating the side view of the mold and thermoplastic components and other mold of FIG. 2D and an active heating element 110, according to various embodiments. In some examples, the heating element 110 heats the thermoplastic components 108 such that the adhesive 106 at least partially evaporates. This evaporation, in some embodiments, helps to facilitate removal of the thermoplastic components 108 from the mold 102. In other embodiments, evaporation of the adhesive 106 is beneficial to remove the adhesive 106. In some embodiments, the adhesive 106 is a material that sets over time and is applied in a liquid state to the mold 102. In the embodiments, the adhesive 106 initially allows some movement of the thermoplastic components 108 before the adhesive 106 sets.

In some examples, the heating element 110 is configured to heat the thermoplastic material 120 to a temperature that is greater than or equal to a glass transition temperature of the thermoplastic material 120 and less than a melting temperature of the thermoplastic material 120. In some examples, the heating element 110 is configured to heat the thermoplastic material 120 to a temperature that is equal to, slightly below, and/or slightly above the melting point of the thermoplastic material 120. In various examples, the heating element 110 is configured to heat the thermoplastic material 120 to a temperature that is within 5 percent of the melting point. In some examples, the heating element 110 is configured to heat the thermoplastic material 120 to a temperature that is not less than 170 degrees Celsius and not less than 180 degrees Celsius. In some examples, the heating element 110 is configured to heat the thermoplastic material 120 to a temperature that is not less than 155 degrees Celsius and not less than 185 degrees Celsius. In some examples, the heating element 110 is configured to heat the thermoplastic material 120 to a temperature that is not less than 130 degrees Celsius and not greater than 180 degrees Celsius.

In some examples, the heating element 110 is configured to heat the thermoplastic material 120 for approximately 10 minutes. In other embodiments, the heating element 110 is configured to heat the thermoplastic material 120 for a longer or shorter period of time, depending on the thermoplastic material 120, size of the molds 102, 114, material of the molds 102, 114, etc. In various examples, the apparatus 100 includes a sensing element configured to measure a temperature of the thermoplastic material. In some examples, the sensing element includes a temperature probe. In response to determining, based on a reading from the temperature probe, that the thermoplastic material has reached a desired temperature, the apparatus 100 terminates the heating process and initiates the cooling process via cooling element 116, as illustrated in FIG. 2F.

FIG. 2F is a side section view illustrating the side view of the mold and thermoplastic components and other mold of FIG. 2D and an active cooling element 116, according to various embodiments. In some examples, the cooling element 116 is configured to cool the thermoplastic material 120 of the thermoplastic components 108. In some examples, the cooling element 116 is configured to cool the thermoplastic material 120 for approximately 10 minutes before removing the sandwich composite structure 118 from the mold 102. In other embodiments, the colling element 116 is configured to cool the thermoplastic material 120 for a longer or a shorter amount of time, depending on the material and/or size of the molds 102, 114, the composition of the thermoplastic material 120, etc. In some examples, the apparatus 100 does not include a cooling element 116 but instead allows the thermoplastic material 120 to cool by removing the thermoplastic material 120 from exposure to heat from the heating element 110.

According to some examples, the cooling element 116 is configured to cool the thermoplastic components 108 at a rate based on a desired stiffness and/or permeability of the end-product sandwich composite. In some examples, the apparatus 100 includes a Dynamic Mechanical Analyzer (“DMA”) instrument configured to characterize the thermoplastic material 120 prior to heating and cooling. In some examples, the apparatus 100 is configured to receive input that includes results from a DMA test. In various examples, cooling rate is based at least in part on results from the DMA test for that thermoplastic material 120. In some examples, the heating element 110 is also configured to heat the thermoplastic material to a temperature determined based at least in part on the results of the DMA test. In some examples, the heating element 110 is configured to heat the thermoplastic material 120 to a temperature at which the storage modulus of that thermoplastic material 120 rapidly drops during the DMA test.

In some examples, the cooling element 116 is an air cooler. In various examples, the cooling element 116 air cools the thermoplastic material at a rate of not less than 1.5 and not greater than 2.5 degrees Celsius per minute. In some examples, the cooling element 116 is configured to air cool the thermoplastic material at a rate of approximately 2 degrees Celsius per minute.

In some examples, the cooling element 116 is a water cooler. In some examples, the cooling element 116 is configured to water cool the thermoplastic material 120 at a rate of not less than 13 and not greater than 21 degrees Celsius per minute. In some examples, the cooling element 116 is configured to water cool the thermoplastic material 120 at a rate of approximately 17 degrees Celsius per minute.

In some examples, the cooling element 116 is configured to cool the thermoplastic material 120 such that, upon completion of cooling, the thermoplastic components 108 are welded together. In some examples, the apparatus 100 is configured to continue to apply pressure to the thermoplastic components 108 during cooling. In some examples, the apparatus 100 continues to apply pressure via the other mold 114 while the cooling element 116 cools the thermoplastic material.

FIG. 2G is a side section view illustrating a sandwich composite 118, according to various embodiments. The sandwich composite 118, in some examples, includes a plurality of thermoplastic components 108, a first sheet 202, and a second sheet 204 and is removed from the mold 102. In some examples, applying the pressure to the thermoplastic components 108 includes compressing the thermoplastic components 108 such that a distance d2 between the first sheet 202 and the second sheet 204 is less than a maximum dimension d1 of the thermoplastic components 108.

In various examples, the thermoplastic components 108 are substantially spherical, and the maximum dimension d1 is a diameter of the thermoplastic components 108. In one or more examples, the distance d2 between the first sheet 202 and the second sheet 204 is not less than 40 percent and not greater than 80 percent of the original diameter d1 of the substantially spherical thermoplastic components 108. In some examples, the distance d2 between the first sheet 202 and the second sheet 204, or the height of the compressed thermoplastic components 108, is approximately 60 percent of the original diameter d1 of the substantially spherical thermoplastic components 108. In some examples, the original diameter d1 of the thermoplastic components 108 is not less than 5 and not greater than 15 millimeters (“mm”).

In some examples, there are no or minimal gaps between thermoplastic components 108 in the sandwich composite 118. In various examples, any gaps between the thermoplastic components 108 are filled with thermoplastic material 120. In some examples, the pressure applicator compresses adjacent thermoplastic components 108 such that they are at least 70 percent in contact with each other via their adjacent sides.

In some examples, the apparatus 100 is configured to form a multi-layer sandwich composite, and the sandwich composite 118 includes one layer of the multi-layer sandwich composite. In various examples, the apparatus 100 is configured to insert another plurality of thermoplastic components 108 onto the first sheet 202 in a similar manner in which the thermoplastic components 108 are inserted into the mold 102. In one or more examples, the apparatus 100 is configured to heat and/or apply pressure onto the additional thermoplastic components 108 towards the first sheet 202.

In some examples, the apparatus 100 performs the heating and pressurizing of each layer 118 concurrently. In other examples, the apparatus 100 performs the heating and pressurizing of each layer 118 sequentially. In some examples, the apparatus 100 applies adhesive material 106 between each layer 118. In various examples, the apparatus 100 is configured to insert the thermoplastic components 108 onto the first sheet 202 while the sandwich composite is within the mold 102. In other examples, the apparatus 100 is configured to insert the thermoplastic components 108 onto the first sheet 202 after the sandwich composite 118 is removed from the mold 102.

In some examples, the adhesive material 106 connects the thermoplastic components 108 to the first sheet 202 and the second sheet 204. In various examples, the adhesive material 106 is applied not only to the inner wall 104 of the mold 102 but also to an inner wall of the other mold 114 and/or onto the thermoplastic components 108 themselves. In various examples, the sandwich composite 118 does not include adhesive 106, but the thermoplastic components 108 are welded to the sheets 202 and 204. In some examples, the sheets 202, 204, and thermoplastic components 108 form a monolithic structure.

FIG. 2H is a top plan view illustrating a honeycomb structure of the sandwich composite 118, according to various embodiments. In some examples, the thermoplastic components 108, after heating and compression, as substantially hexagonal in shape and are joined together by at least one of the sheets 202 to form a honeycomb structure. In various examples, the core the of the sandwich composite 118 is the honeycomb arrangement of the compressed thermoplastic components 108.

In some examples, the distance d2 is the thickness of the core of the sandwich composite 118. In various examples, each of the thermoplastic components 108 is open to the first sheet 202 and the second sheet 204 but closed in the thickness direction, or in a direction not intersecting the first sheet 202 or the second sheet 204. In some examples, the thermoplastic materials 108 are closed in a direction that is skew with respect to the first sheet 202 and/or the second sheet 204. In some examples, the sandwich composite 118 includes a bidirectional structure. In various examples, the sandwich composite 118 provides stiffness in both the direction of the thickness d2 and a direction 90 degrees with respect to the thickness d2 and parallel to the first sheet 202.

In some examples, the sandwich composite 118 is part of a Gas Barrier Sandwich Structured (“GABS”) liner composite pressure vessel (“CPV”). In some examples, the apparatus 100 is configured to coat the sandwich composite 118 with a coating, such as a nanocomposite coating. In some examples, the apparatus 100 is configured to laminate at least one of the sheets 202 and 204 with a nano brick wall having a thickness of less than 100 micrometers. In some examples, the coating is made of a material having hydrogen and/or helium gas blocking properties. In some examples, the apparatus 100 is configured to chemically bond the coating to the thermoplastic material 120.

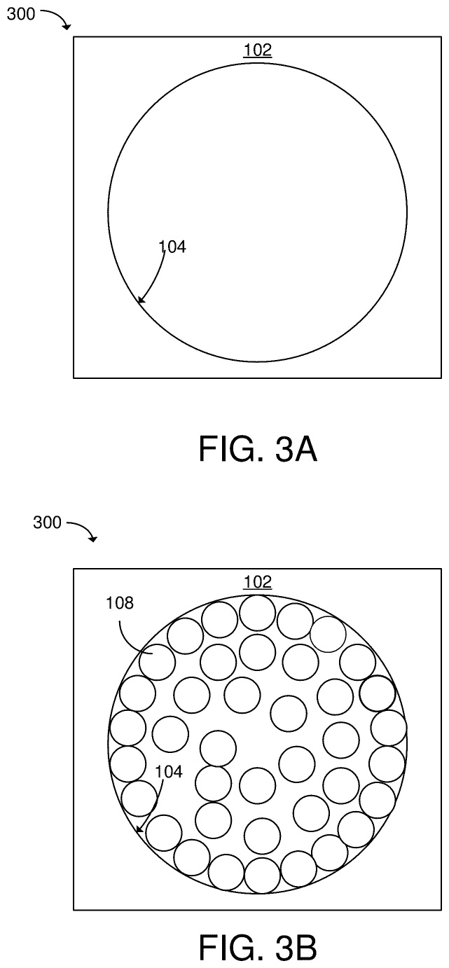

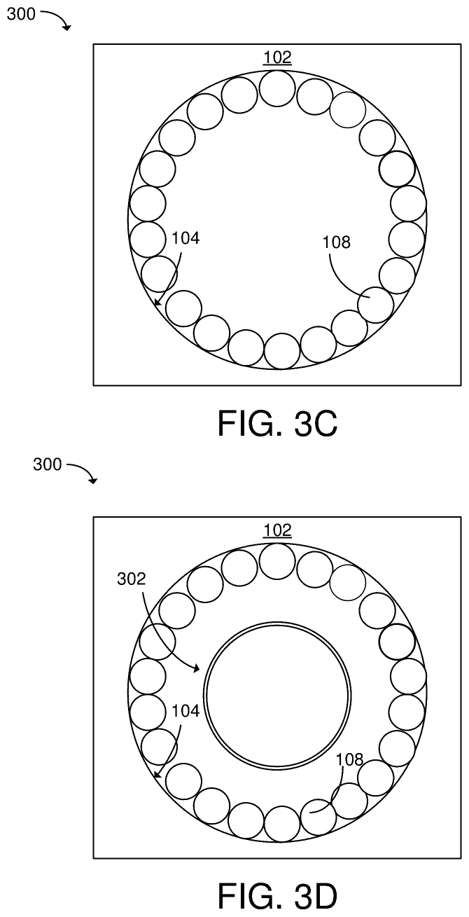

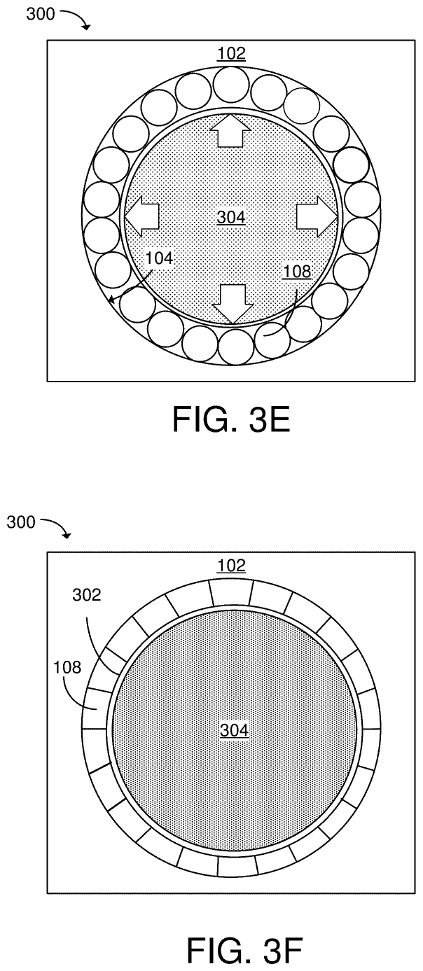

FIG. 3A is a top cross section view illustrating one example of a mold 102 of an apparatus 300 for hollow ball cores for sandwich structured composites, according to various embodiments. In some examples, the apparatus 300 is an embodiment of the apparatus 100. In some examples, the inner wall 104 defines a cavity with a closed shape. FIG. 3B is a top cross section view illustrating a plurality of thermoplastic components 108 inserted into a mold 102 of the apparatus 300 of FIG. 3A, according to various embodiments.

FIG. 3C is a top cross section view illustrating one example of the mold 102 of FIG. 3A with a subset of the plurality of thermoplastic components 108 adhered to an inner wall 104 of the mold 102, according to various embodiments. In some examples, some of the thermoplastic components 108 are removed. In some examples, the removed thermoplastic components 108 are thermoplastic components that are not adhered to the inner wall 104.

In some examples, the apparatus 300 is configured to remove some of the thermoplastic components 108 from the mold 102 by extracting the thermoplastic components 108 manually (e.g., via robotic placement) and/or via vacuum, such that any thermoplastic components 108 not adhered to the inner wall 104 are removed. According to one or more examples, the apparatus 300 is configured to remove some of the thermoplastic components 108 through a gravity mechanism. In some examples, the apparatus 300 is configured to invert and/or open up a bottom of the mold 102 to drain any non-adhered thermoplastic components 108.

FIG. 3D is a top cross section view illustrating the mold 102 and thermoplastic components 108 of FIG. 3C with an uninflated bladder 302, according to various embodiments. In some examples, removing some of the thermoplastic components 108 from the mold 102 prior to applying pressure onto the adhered thermoplastic components 108 helps to facilitate placement of the bladder 302 within the mold 102.

FIG. 3E is a top cross section view illustrating the mold 102 and thermoplastic components 108 of FIG. 3C with the bladder 302 being filled. In some examples, applying pressure to the thermoplastic components 108 includes filling the bladder 302, according to various embodiments. In various examples, the bladder 302 is made of a flexible material. In some examples, the bladder 302 is made of at least one of: rubber, a thermoplastic material, polyurethane, polyvinyl chloride, silicone, a synthetic rubber, a polymeric material, polyisoprene, latex, or a combination thereof. In one or more examples, apply pressure to the thermoplastic components 108 includes filling the bladder 302 with fluid 304, such as oxygen. In various examples, the bladder 302 comes into contact and/or is in contact with the thermoplastic components 108, and filling the bladder 302 with the fluid 304 applies pressure on the thermoplastic components 108.

In some examples, the fluid 304 is a heated fluid. In various examples, the heating element 110 includes the bladder 302 and/or fluid 304. In one or more examples, the heating element 110 heats the bladder 302 and/or fluid 304. In some examples, the bladder 302 heats the thermoplastic components 108 by allowing heat to transfer from and/or through the bladder 302 to the thermoplastic components 108.

FIG. 3F is a top cross section view illustrating the mold 102 and thermoplastic components 108 of FIG. 3C with the bladder 302 filled with a fluid 304, according to various embodiments. As shown in FIG. 3F, in some examples, the bladder 302 is filled with fluid 304 such that each of the thermoplastic components 108 are in contact with the bladder 302. In other examples, the bladder 302 is configured to be filled with fluid 304 and then moved around the inner wall 104 to apply pressure to the thermoplastic components 108 sequentially.

FIG. 4 is a side elevation view illustrating a mold 402 having a variable depth and thermoplastic components 108 of various diameters, according to various embodiments. In some examples, the mold 402 is an embodiment of the mold 102 illustrated in FIGS. 1-3F. In some examples, the mold 402 has a variable depth and the plurality of thermoplastic components 108 have different dimensions corresponding to the variable depth of the mold 402. In some examples, the diameter d1 of a thermoplastic component 108-1 is equal to a depth of a cavity 404 of the mold 402 at a location at which the thermoplastic component 108-1 is placed into the mold 402. In various examples, another thermoplastic component 108-2 is placed into the cavity 404 of the mold 402 at a more shallow location and has a lesser diameter d3. In some examples, the maximum dimension (e.g., diameter d1 and d3) of the thermoplastic component 108 is less than but still corresponds to the depth of the mold cavity 404 at the location in which the thermoplastic component 108 is placed. In some examples, the variation of the variable depth is non-linear, and the variable depth includes at least three different depth values. In some examples, the mold 402 is part of a mold for a complex shape, such as an aircraft propeller.

FIG. 5 is a schematic block diagram illustrating of an apparatus 500 with a mold 102 with adhesive 106 and thermoplastic components 108 and with a gas pressure applicator 502, according to various embodiments. In some examples, the apparatus 500 is an embodiment of the apparatus 100 illustrated in FIG. 1, and the gas pressure applicator 502 is an embodiment of the pressure applicator 112. In some examples the gas pressure applicator 502 is configured to apply pressure to the thermoplastic components 108 via blow molding. In some examples, the apparatus 500 applies pressure onto the thermoplastic components 108 by applying gas pressure onto the plurality of thermoplastic components 108 towards the mold 102 via the gas pressure applicator 502.

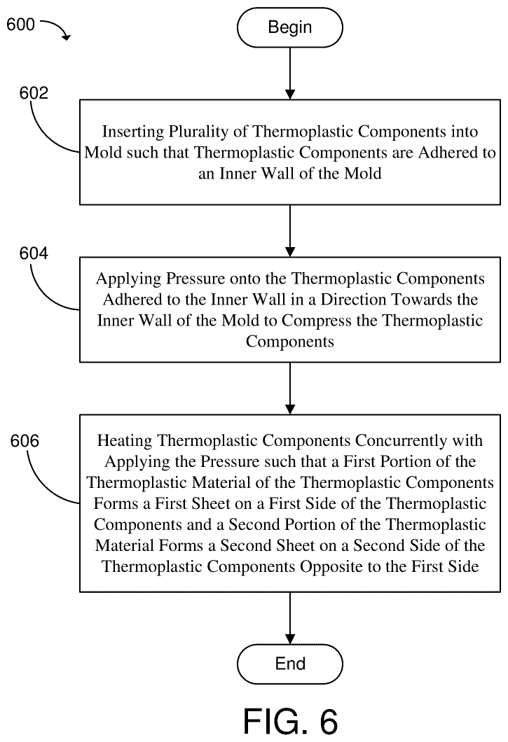

FIG. 6 is a schematic flow chart diagram illustrating one embodiment of a method 600 of manufacturing a sandwich-structured composite. The method 600 begins and includes inserting 602 a plurality of thermoplastic components 108 into a mold 102 such that at least two or more thermoplastic components 108 of the plurality of thermoplastic components 108 are adhered to the inner wall 104 of the mold 102 via the adhesive material 106. The plurality of thermoplastic components 108 are substantially hollow and made of a thermoplastic material 120. The method 600 includes applying 604 pressure onto the two or more thermoplastic components 108 adhered to the inner wall 104 in a direction towards the inner wall 104 of the mold 102 to compress the plurality of thermoplastic components 108. The method 600 includes heating 606 the plurality of thermoplastic components 108 concurrently with applying the pressure such that a first portion of the thermoplastic material 120 of the thermoplastic components 108 forms a first sheet 202 on a first side of the plurality of thermoplastic components 108 and a second portion of the thermoplastic material 120 of the thermoplastic components 108 forms a second sheet 204 on a second side of the plurality of thermoplastic components 108 opposite to the first side. The first sheet 202 connects the plurality of thermoplastic components 108.

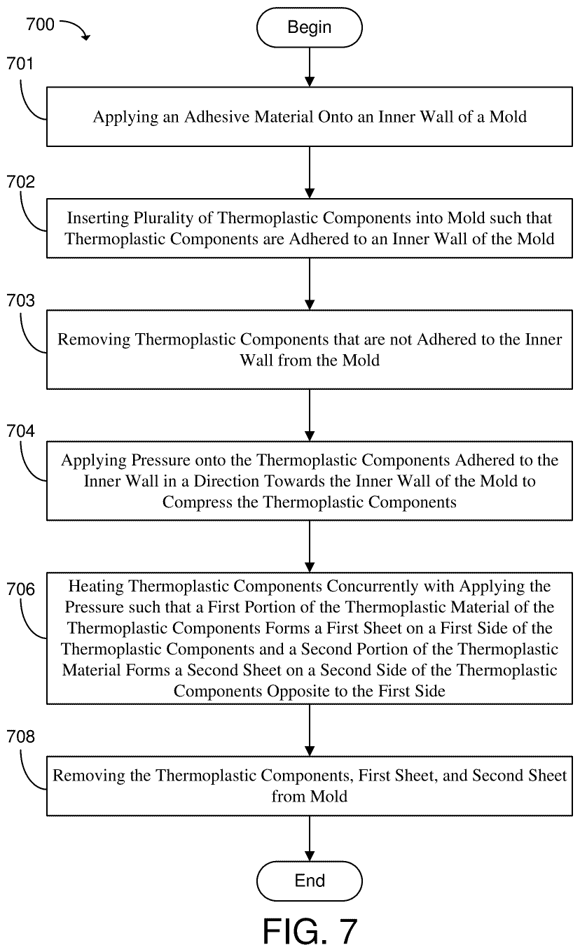

FIG. 7 is a schematic flow chart diagram illustrating another example of a method 700 of manufacturing a sandwich-structured composite. In some examples, the method 700 includes steps of the method 600. In some examples, the method 700 includes applying 701 an adhesive material 106 onto an inner wall 104 of a mold 102. The mold 102 has a variable depth. The method 700 includes inserting 702 a plurality of thermoplastic components 108 into the mold 102 such that thermoplastic components 108 of the plurality of thermoplastic components 108 are adhered to the inner wall 104 of the mold 102 via the adhesive material 106 and substantially cover the inner wall 104 of the mold 102. The plurality of thermoplastic components 108 are substantially hollow, are made of a thermoplastic material 120, and have different dimensions corresponding to the variable depth of the mold 102. The method 700 includes removing 703 thermoplastic components 108 of the plurality of thermoplastic components 108 that are not adhered to the inner wall 104 from the mold 102. The method 700 includes applying 704 pressure onto the two or more thermoplastic components 108 adhered to the inner wall 104 in a direction towards the inner wall 104 of the mold 102 to compress the plurality of thermoplastic components 108 by: disposing the plurality of thermoplastic components 108 between the mold 102 and another mold 114, and moving the mold 102 and the another mold 114 towards each other; applying gas pressure onto the plurality of thermoplastic components 108 towards the mold 102; and/or filling a bladder 302 that is in contact with the thermoplastic components 108, thus applying pressure on the thermoplastic components 108. The method 700 includes heating 706 the plurality of thermoplastic components 108 concurrently with applying the pressure such that: (1) a first portion of the thermoplastic material 120 of the thermoplastic components 108 forms a first sheet 202 on a first side of the plurality of thermoplastic components 108; (2) a second portion of the thermoplastic material 120 of the thermoplastic components 108 forms a second sheet 204 on a second side of the plurality of thermoplastic components 108 opposite to the first side where the first sheet 202 connects the plurality of thermoplastic components 108; and (3) the adhesive 106 at least partially evaporates. The method 700 includes removing 708 the plurality of thermoplastic components 108, the first sheet 202, and the second sheet 204 from the mold 102.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
inserting a plurality of thermoplastic components into a mold such that at least two or more thermoplastic components of the plurality of thermoplastic components are adhered to an inner wall of the mold, wherein the plurality of thermoplastic components are substantially hollow and made of a thermoplastic material;
applying pressure onto the two or more thermoplastic components adhered to the inner wall in a direction towards the inner wall of the mold to compress the plurality of thermoplastic components; and
heating the plurality of thermoplastic components concurrently with applying the pressure such that a first portion of the thermoplastic material of the thermoplastic components forms a first sheet on a first side of the plurality of thermoplastic components and a second portion of the thermoplastic material of the thermoplastic components forms a second sheet on a second side of the plurality of thermoplastic components opposite to the first side, wherein the first sheet connects the plurality of thermoplastic components.

2. The method of claim 1, wherein the mold has a variable depth and the plurality of thermoplastic components have different dimensions corresponding to the variable depth of the mold.

3. The method of claim 2, wherein the variation of the variable depth is non-linear and the variable depth comprises at least three different depth values.

4. The method of claim 1, further comprising removing thermoplastic components of the plurality of thermoplastic components that are not adhered to the inner wall from the mold prior to applying pressure onto the two or more thermoplastic components adhered to the inner wall.

5. The method of claim 1, wherein applying the pressure comprises at least one of:
disposing the plurality of thermoplastic components between the mold and another mold, and moving the mold and the another mold towards each other;
applying gas pressure onto the plurality of thermoplastic components towards the mold; and/or
filling a bladder, wherein the bladder is in contact with the thermoplastic components and filling the bladder applies pressure on the thermoplastic components.

6. The method of claim 1, further comprising applying an adhesive material onto an inner wall of the mold prior to inserting the plurality of thermoplastic components into the mold, wherein the plurality of thermoplastic components are adhered to the inner wall of the mold via the adhesive material and heating the plurality of thermoplastic components comprises heating the plurality of thermoplastic components such that:
the adhesive material at least partially evaporates; and
the plurality of thermoplastic components, the first sheet, and the second sheet are removable from the mold.

7. The method of claim 1, wherein the thermoplastic components are substantially spherical when inserted into the mold and applying pressure to the plurality of thermoplastic components comprises compressing the thermoplastic components such that the thermoplastic components are not spherical.

8. The method of claim 7, wherein applying the pressure to the plurality of thermoplastic components comprises compressing the thermoplastic components such that the thermoplastic components are shaped substantially similar to a hexagonal prism.

9. The method of claim 7, wherein applying the pressure to the plurality of thermoplastic components comprises compressing the thermoplastic components such that the thermoplastic components form a honeycomb structure between the first sheet and the second sheet.

10. The method of claim 7, wherein applying the pressure to the plurality of thermoplastic components comprises compressing the thermoplastic components such that a distance between the first sheet and the second sheet is not less than 40 percent and not greater than 80 percent of a diameter of the substantially spherical thermoplastic components.

11. The method of claim 1, further comprising cooling the thermoplastic material.

12. The method of claim 11, wherein the thermoplastic material comprises polypropylene and cooling the thermoplastic material comprises air cooling the thermoplastic material at a rate of not less than 1.5 and not greater than 5.5 degrees Celsius per minute.

13. The method of claim 11, wherein the thermoplastic material comprises polypropylene and cooling the thermoplastic material comprises water cooling the thermoplastic material at a rate of not less than 13 and not greater than 21 degrees Celsius per minute.

14. The method of claim 1, wherein heating the plurality of thermoplastic components comprises heating the plurality of thermoplastic components to a temperature that is greater than or equal to a glass transition temperature of the thermoplastic material and less than a melting temperature of the thermoplastic material.

15. The method of claim 1, wherein inserting the plurality of thermoplastic components into the mold such that at least two or more thermoplastic components of the plurality of thermoplastic components are adhered to the inner wall of the mold comprises the inner wall being substantially covered with the thermoplastic components.

16. An apparatus comprising:
a mold comprising an inner wall;
a plurality of thermoplastic components configured to be inserted into the mold such that at least two or more thermoplastic components of the plurality of thermoplastic components are adhered to the inner wall of the mold, wherein the plurality of thermoplastic components are substantially hollow and made of a thermoplastic material;
a pressure applicator, the pressure applicator configured to apply pressure onto the two or more thermoplastic components adhered to the inner wall in a direction towards the inner wall of the mold to compress the plurality of thermoplastic components; and
a heater configured to heat the plurality of thermoplastic components concurrently with the pressure applicator applying the pressure such that a first portion of the thermoplastic material of the thermoplastic components forms a first sheet on a first side of the plurality of thermoplastic components and a second portion of the thermoplastic material of the thermoplastic components forms a second sheet on a second side of the plurality of thermoplastic components opposite to the first side, wherein the first sheet connects the plurality of thermoplastic components.

17. The apparatus of claim 16, wherein the pressure applicator comprises at least one of the following:
another mold;
a press configured to move the mold and the another mold towards each other;
a pressurizer configured to apply gas pressure onto the plurality of thermoplastic components towards the mold; and/or
a bladder in contact with the thermoplastic components and configured to be filled to apply pressure on the thermoplastic components.

18. The apparatus of claim 16, further comprising an air cooler configured to cool the thermoplastic material at a rate of not less than 1.5 and not greater than 5.5 degrees Celsius per minute, wherein the thermoplastic material comprises polypropylene.

19. The apparatus of claim 16, further comprising a water cooler configured to cool the thermoplastic material at a rate of not less than 13 and not greater than 21 degrees Celsius per minute.

20. A method, comprising:
applying an adhesive material onto an inner wall of a mold, wherein the mold has a variable depth;
inserting a plurality of thermoplastic components into the mold such that thermoplastic components of the plurality of thermoplastic components are adhered to the inner wall of the mold via the adhesive material and substantially cover the inner wall of the mold, wherein the plurality of thermoplastic components are substantially hollow, are made of a thermoplastic material, and have different dimensions corresponding to the variable depth of the mold;
removing thermoplastic components of the plurality of thermoplastic components that are not adhered to the inner wall from the mold;
applying pressure onto the plurality of thermoplastic components adhered to the inner wall in a direction towards the inner wall of the mold to compress the plurality of thermoplastic components by:
disposing the plurality of thermoplastic components between the mold and another mold, and moving the mold and the another mold towards each other;
applying gas pressure onto the plurality of thermoplastic components towards the mold; and/or
filling a bladder, wherein the bladder is in contact with the thermoplastic components and filling the bladder applies pressure on the thermoplastic components; and
heating the plurality of thermoplastic components concurrently with applying the pressure such that:
a first portion of the thermoplastic material of the thermoplastic components forms a first sheet on a first side of the plurality of thermoplastic components;
a second portion of the thermoplastic material of the thermoplastic components forms a second sheet on a second side of the plurality of thermoplastic components opposite to the first side, wherein the first sheet connects the plurality of thermoplastic components; and
the adhesive material at least partially evaporates; and
removing the plurality of thermoplastic components, the first sheet, and the second sheet from the mold.
